(19) United States
(12) Patent Application Publication
(10) Pub. No.: US 2026/0288347 A1
(43) Pub. Date: Sep. 24, 2026

(54) MEMORY MANAGEMENT METHOD, MEMORY STORAGE DEVICE AND MEMORY CONTROL CIRCUIT UNIT

(71) Applicant: PHISON ELECTRONICS CORP., Miaoli (TW)

(72) Inventors: Yu-Siang Yang, New Taipei City (TW); Ting-Chien Zhan, Hsinchu City (TW); Hua Ting Li, Hsinchu City (TW); Yu-Cheng Hsu, Yilan County (TW)

(73) Assignee: PHISON ELECTRONICS CORP., Miaoli (TW)

(21) Appl. No.: 19/211,263

(22) Filed: May 18, 2025

(30) Foreign Application Priority Data
Mar. 24, 2025 (TW) 114110963

(51) Int. Cl. G06F 3/06

(52) U.S. Cl. CPC G06F 3/0619; G06F 3/0659; G06F 3/0679

(57) ABSTRACT

A memory management method, a memory storage device, and a memory control circuit unit are disclosed. The method includes: executing a multi-stages programing on multiple physical units in a rewritable non-volatile memory module according to first data, where the multi-stages programing includes a first-stage programming and a second-stage programing; saving second data after the multi-stages programing is started and before the second-stage programing is completed, where the second data is generated by encoding the first data; and adjusting a read operation or a programming operation on at least one of the physical units according to the second data.

### CROSS-REFERENCE TO RELATED APPLICATION

This application claims the priority benefit of Taiwan application serial no. 114110963 filed on Mar. 24, 2025. The entirety of the above-mentioned patent application is hereby incorporated by reference herein and made a part of this specification.

### BACKGROUND

### Technical Field

The disclosure relates to a memory management method, a memory storage device, and a memory control circuit unit.

### Related Art

A growth of portable electronic devices such as mobile phones and laptops has been very rapid in recent years, causing the consumer demand for storage media to increase rapidly as well. Since having characteristics such as data non-volatility, power saving, small size, and no mechanical structure, a rewritable non-volatile memory module (for example, a flash memory) is very suitable to be built into various portable electronic devices exemplified above.

Generally, in order to avoid data loss due to incomplete storage caused by unexpected power outage during data writing in a memory storage device, the memory storage device may back up the to-be-stored data that has not been completely stored. Once an unexpected power outage occurs during data writing, after the memory storage device is powered on again, the backup data may be configured to re-execute the write operation for the original to-be-stored data. However, as the amount of data written in each write operation becomes increasingly large, the amount of data that needs to be backed up also increases, which results in excessive occupation of system resources.

### SUMMARY

The disclosure provides a memory management method, a memory storage device, and a memory control circuit unit, which may improve the aforementioned problems.

An embodiment of the disclosure provides a memory management method, which is used for a rewritable non-volatile memory module, the memory management method includes as follows. According to first data, a multi-stages programing is executed on multiple physical units in the rewritable non-volatile memory module, where the multi-stages programing includes a first-stage programming and a second-stage programming. Before starting to execute the multi-stages programing and before completing the second-stage programming, second data is saved, where the second data is generated by encoding the first data. Moreover, according to the second data, a read operation or a programming operation on at least one of the physical units is adjusted.

An exemplary embodiment of the disclosure further provides a memory storage device including a connecting interface unit, a rewritable non-volatile memory module, and a memory control circuit unit. The connecting interface unit is configured to couple to a host system. The memory control circuit unit is coupled to the connecting interface unit and the rewritable non-volatile memory module. The memory control circuit unit is configured to: according to first data, execute a multi-stages programing on multiple physical units in the rewritable non-volatile memory module, where the multi-stages programing includes a first-stage programming and a second-stage programming; before starting to execute the multi-stages programing and before completing the second-stage programming, save second data, where the second data is generated by encoding the first data; and according to the second data, adjust a read operation or a programming operation on at least one of the physical units.

An exemplary embodiment of the disclosure further provides a memory control circuit unit, which is configured to control a rewritable non-volatile memory module. The memory control circuit unit includes a host interface, a memory interface, and a memory management circuit. The host interface is configured to couple to a host system. The memory interface is configured to couple to the rewritable non-volatile memory module. The memory management circuit is coupled to the host interface and the memory interface. The memory management circuit is configured to: according to first data, execute a multi-stages programing on multiple physical units in the rewritable non-volatile memory module, where the multi-stages programing includes a first-stage programming and a second-stage programming; before starting to execute the multi-stages programing and before completing the second-stage programming, save second data, where the second data is generated by encoding the first data; and according to the second data, adjust a read operation or a programming operation on at least one of the physical units.

Based on the above, according to the first data, the multi-stages programing may be executed on the physical units in the rewritable non-volatile memory module. In particular, before starting to execute the multi-stages programing and before completing the second-stage programming of the multi-stages programing, the second data generated by encoding the first data may be saved. Thereafter, the read operation or the programming operation on the at least one of the physical units may be adjusted based on the second data. Thereby, compared to the traditional need to completely backup the first data until the corresponding programming operation is completed, the disclosure, by saving the second data generated by encoding, may obtain the same or better data management and/or data recovery performance.

### BRIEF DESCRIPTION OF THE DRAWINGS

FIG. 1 is a schematic diagram of a host system, a memory storage device, and an input/output (I/O) device according to an exemplary embodiment of the disclosure.

FIG. 2 is a schematic diagram of a host system, a memory storage device, and an I/O device according to an exemplary embodiment of the disclosure.

FIG. 3 is a schematic diagram of a host system and a memory storage device according to an exemplary embodiment of the disclosure.

FIG. 4 is a schematic diagram of a memory storage device according to an exemplary embodiment of the disclosure.

FIG. 5 is a schematic diagram of a memory control circuit unit according to an exemplary embodiment of the disclosure.

FIG. 6 is a schematic diagram of management of a rewritable non-volatile memory module according to an exemplary embodiment of the disclosure.

FIG. 7A is a schematic diagram of execution of stage programming on a physical unit of a rewritable non-volatile memory module to store data according to an exemplary embodiment of the disclosure.

FIG. 7B is a schematic diagram of reading of data from a programmed physical unit according to an exemplary embodiment of the disclosure.

FIG. 8 is a schematic diagram of encoding of first data to generate second data according to an exemplary embodiment of the disclosure.

FIG. 9A is a schematic diagram of a threshold voltage distribution of memory cells after a first-stage programming according to an exemplary embodiment of the disclosure.

FIG. 9B is a schematic diagram of a threshold voltage distribution of memory cells after grouping according to an exemplary embodiment of the disclosure.

FIG. 10 is a schematic diagram of an adjustment of read voltage levels according to an exemplary embodiment of the disclosure.

FIG. 11 is a schematic diagram of an adjustment of decoding parameters according to an exemplary embodiment of the disclosure.

FIG. 12 is a schematic diagram of a correction of error bits according to second data according to an exemplary embodiment of the disclosure.

FIG. 13 is a schematic diagram of interleaved programming for memory cells on multiple word lines according to an exemplary embodiment of the disclosure.

FIG. 14 is a flowchart of a memory management method according to an exemplary embodiment of the disclosure.

FIG. 15 is a flowchart of a memory management method according to an exemplary embodiment of the disclosure.

### DESCRIPTION OF THE EMBODIMENTS

In general, a memory storage device (also called a memory storage system) includes a rewritable non-volatile memory module and a controller (also called a control circuit). The memory storage device may be used with a host system, so that the host system may write data to the memory storage device or read data from the memory storage device.

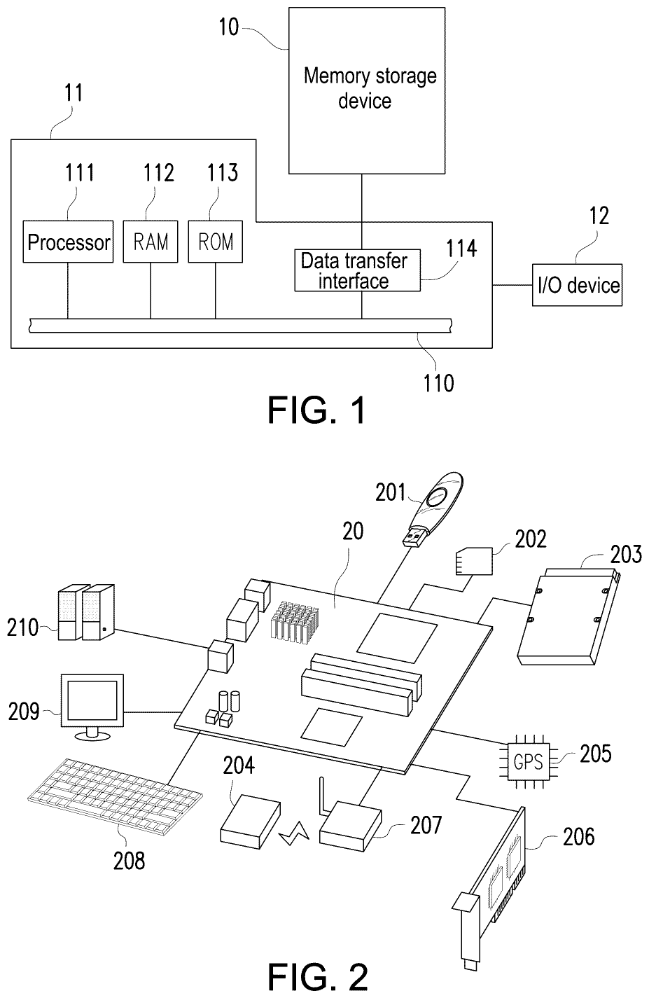

FIG. 1 is a schematic diagram of a host system, a memory storage device, and an input/output (I/O) device according to an exemplary embodiment of the disclosure. FIG. 2 is a schematic diagram of a host system, a memory storage device, and an I/O device according to an exemplary embodiment of the disclosure.

Referring to FIG. 1 and FIG. 2, a host system 11 may include a processor 111, a random access memory (RAM) 112, a read only memory (ROM) 113, and a data transfer interface 114. The processor 111, the RAM 112, the ROM 113, and the data transfer interface 114 may be coupled to a system bus 110.

In an exemplary embodiment, the host system 11 may be coupled to a memory storage device 10 through the data transfer interface 114. For example, the host system 11 may store data to the memory storage device 10 or read data from the memory storage device 10 through the data transfer interface 114. In addition, the host system 11 may be coupled to the I/O device 12 through the system bus 110. For example, the host system 11 may transmit output signals to the I/O device 12 or receive input signals from the I/O device 12 via the system bus 110.

In an exemplary embodiment, the processor 111, the RAM 112, the ROM 113, and the data transfer interface 114 may be disposed on a host board 20 of the host system 11. A number of the data transfer interface 114 may be one or multiple. Through the data transfer interface 114, the host board 20 may be coupled to the memory storage device 10 in a wired or wireless manner.

In an exemplary embodiment, the memory storage device 10 may be, for example, a flash drive 201, a memory card 202, a solid state drive (SSD) 203, or a wireless memory storage device 204. The wireless memory storage device 204 may be, for example, a near field communication (NFC) memory storage device, a WiFi memory storage device, a Bluetooth memory storage device, or a low-power Bluetooth memory storage device (for example, iBeacon), which are memory storage devices based on various wireless communication technologies. In addition, the host board 20 may also be coupled to a global positioning system (GPS) module 205, a network interface card 206, a wireless transmission device 207, a keyboard 208, a screen 209, a speaker 210, and other various I/O devices through the system bus 110. For example, in an exemplary embodiment, the host board 20 may access the wireless memory storage device 204 through the wireless transmission device 207.

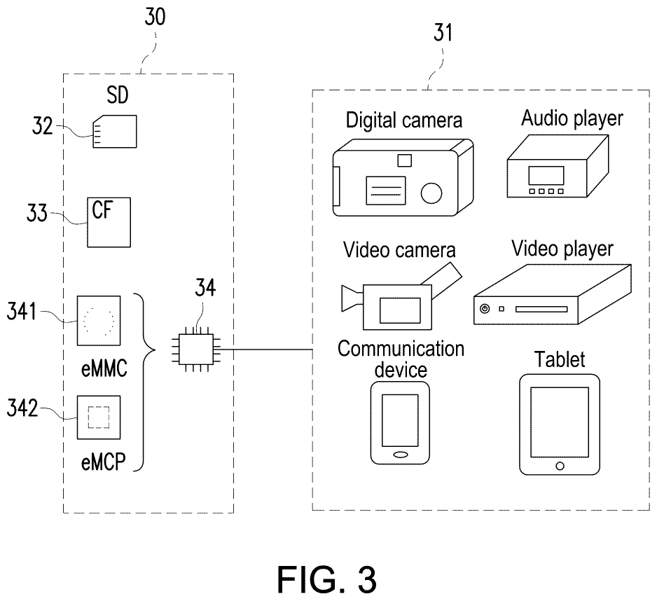

In an exemplary embodiment, the host system 11 is a computer system. In an exemplary embodiment, the host system 11 may be any system that can substantially cooperate with the memory storage device to store data. In an exemplary embodiment, the memory storage device 10 and the host system 11 may respectively include a memory storage device 30 and a host system 31 in FIG. 3.

FIG. 3 is a schematic diagram of a host system and a memory storage device according to an exemplary embodiment of the disclosure. Referring to FIG. 3, the memory storage device 30 may be used with the host system 31 to store data. For example, the host system 31 may be a systems such as a digital camera, a video camera, a communication device, an audio player, a video player, or a tablet. For example, the memory storage device 30 may be a various non-volatile memory storage device such as a secure digital (SD) memory card 32, a compactflash 33, or an embedded storage device 34 used by the host system 31. The embedded storage device 34 includes various types of embedded storage devices that directly couple memory modules to a substrate of the host system, such as an embedded multi media card 341 and/or an embedded multi chip package storage device 342.

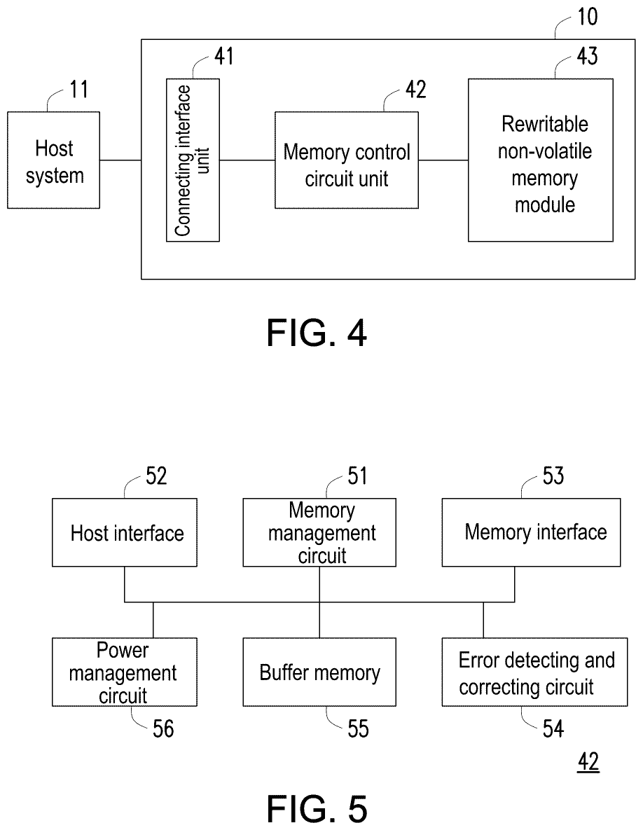

FIG. 4 is a schematic diagram of a memory storage device according to an exemplary embodiment of the disclosure. Referring to FIG. 4, the memory storage device 10 includes a connecting interface unit 41, a memory control circuit unit 42, and a rewritable non-volatile memory module 43.

The connecting interface unit 41 is configured to couple the memory storage device 10 to the host system 11. The memory storage device 10 may communicate with the host system 11 through the connecting interface unit 41. In an exemplary embodiment, the connecting interface unit 41 is compatible with the Peripheral Component Interconnect Express (PCI Express) standard. In an exemplary embodiment, the connecting interface unit 41 may also conform to the Serial Advanced Technology Attachment (SATA) standard, Parallel Advanced Technology Attachment (PATA) standard, Institute of Electrical and Electronic Engineers (IEEE) 1394 standard, Universal Serial Bus (flash drive) standard, SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, compactflash interface standard, Integrated Device Electronics (IDE) standard, or other suitable standards. The connecting interface unit 41 may be packaged with the memory control circuit unit 42 in one chip, or the connecting interface unit 41 may be arranged outside a chip including the memory control circuit unit 42.

The memory control circuit unit 42 is coupled to the connecting interface unit 41 and the rewritable non-volatile memory module 43. The memory control circuit unit 42 is configured to execute multiple logic gates or control commands implemented in a hardware form or a firmware form, and to perform operations such as writing, reading, and erasing on data in the rewritable non-volatile memory module 43 according to the commands of the host system 11.

The rewritable non-volatile memory module 43 is configured to store data written by the host system 11. The rewritable non-volatile memory module 43 may include a single level cell (SLC) NAND flash memory module (that is, a flash memory module in which one memory cell may store 1 bit), a multi level cell (MLC) NAND flash memory module (that is, a flash memory module in which one memory cell may store 2 bits), a triple level cell (TLC) NAND flash memory module (that is, a flash memory module in which one memory cell may store 3 bits), a quad level cell (QLC) NAND flash memory module (that is, a flash memory module in which one memory cell may store 4 bits), other flash memory modules, or other memory modules with the same characteristics.

Each memory cell in the rewritable non-volatile memory module 43 stores one or multiple bits by changing a voltage (hereinafter also referred to as a threshold voltage). Specifically, there is a charge trapping layer between a control gate and a channel of each memory cell. By applying a write voltage to the control gate, an amount of electrons in the charge trapping layer may be changed, thereby changing the threshold voltage of the memory cell. The operation of changing the threshold voltage of the memory cell is also called “writing data to the memory cell” or “programming the memory cell”. With a change of threshold voltage, each memory cell in the rewritable non-volatile memory module 43 has multiple storage states. By applying a read voltage, it may be determined which storage state a memory cell belongs to, thereby obtaining one or multiple bits stored in this memory cell.

In an exemplary embodiment, the memory cells in the rewritable non-volatile memory module 43 may compose multiple physical programming units, and these physical programming units may compose multiple physical erasing units. Specifically, memory cells on the same word line may form one or multiple physical programming units. If each memory cell may store more than two bits, then the physical programming units on the same word line may be classified into at least lower physical programming units and upper physical programming units. For example, a least significant bit (LSB) of the memory cell belongs to the lower physical programming unit, and the most significant bit (MSB) of the memory cell belongs to the upper physical programming unit. Generally, in MLC NAND flash memory, a writing speed of the lower physical programming unit is greater than a writing speed of the upper physical programming unit, and/or reliability of the lower physical programming unit is higher than reliability of the upper physical programming unit.

In an exemplary embodiment, the physical programming unit is a minimum unit for programming. That is, the physical programming unit is the minimum unit for writing data. For example, the physical programming unit may be a physical page or a physical sector. If the physical programming unit is a physical page, the physical programming unit may include a data bit area and a redundancy bit area. The data bit area includes multiple physical sectors configured to store user data, while the redundancy bit area is configured to store system data (for example, error correcting codes and other management data). In an exemplary embodiment, the data bit area includes 32 physical sectors, and a size of a physical sector is 512 bytes (B). However, in other exemplary embodiments, the data bit area may also include 8, 16, or more or fewer physical sectors, and a size of each physical sector may also be larger or smaller. On the other hand, the physical erasing unit is the minimum unit for erasing. That is, each physical erasing unit includes the minimum number of memory cells that are erased together. For example, the physical erasing unit is a physical block.

FIG. 5 is a schematic diagram of a memory control circuit unit according to an exemplary embodiment of the disclosure. Referring to FIG. 5, the memory control circuit unit 42 includes a memory management circuit 51, a host interface 52, and a memory interface 53.

The memory management circuit 51 is configured to control the overall operation of the memory control circuit unit 42. Specifically, the memory management circuit 51 has multiple control commands, and when the memory storage device 10 operates, these control commands are executed to perform operations such as data writing, reading, and erasing. The following description of the operation of the memory management circuit 51 is equivalent to the description of the operation of the memory control circuit unit 42.

In an exemplary embodiment, the control commands of the memory management circuit 51 are implemented in the firmware form. For example, the memory management circuit 51 has a microprocessor unit (not shown) and a ROM (not shown), and these control commands are burned into this ROM. When the memory storage device 10 operates, these control commands are executed by the microprocessor unit to perform operations such as data writing, reading, and erasing.

In an exemplary embodiment, the control commands of the memory management circuit 51 may also be stored in a code form in a specific area (for example, a system area of the memory module dedicated to storing system data) of the rewritable non-volatile memory module 43. Additionally, the memory management circuit 51 has a microprocessor unit (not shown), a ROM (not shown), and a RAM (not shown). In particular, this ROM has a boot code, and when the memory control circuit unit 42 is enabled, the microprocessor unit first executes this boot code to load the control commands stored in the rewritable non-volatile memory module 43 into the RAM of the memory management circuit 51. Subsequently, the microprocessor unit operates these control commands to perform operations such as data writing, reading, and erasing.

In an exemplary embodiment, the control commands of the memory management circuit 51 may also be implemented in the hardware form. For example, the memory management circuit 51 includes a microcontroller, a memory cell management circuit, a memory writing circuit, a memory reading circuit, a memory erasing circuit, and a data processing circuit. The memory cell management circuit, the memory writing circuit, the memory reading circuit, the memory erasing circuit, and the data processing circuit are coupled to the microcontroller. The memory cell management circuit is configured to manage the memory cells or memory cell groups of the rewritable non-volatile memory module 43. The memory writing circuit is configured to issue write command sequences to the rewritable non-volatile memory module 43 to write data into the rewritable non-volatile memory module 43. The memory reading circuit is configured to issue read command sequences to the rewritable non-volatile memory module 43 to read data from the rewritable non-volatile memory module 43. The memory erasing circuit is configured to issue erase command sequences to the rewritable non-volatile memory module 43 to erase data from the rewritable non-volatile memory module 43. The data processing circuit is configured to process data to be written to the rewritable non-volatile memory module 43 and data read from the rewritable non-volatile memory module 43. The write command sequences, read command sequences, and erase command sequences may each include one or multiple codes or instructions and are configured to instruct the rewritable non-volatile memory module 43 to execute corresponding write, read, and erase operations. In an exemplary embodiment, the memory management circuit 51 may also issue other types of command sequences to the rewritable non-volatile memory module 43 to instruct the execution of corresponding operations.

The host interface 52 is coupled to the memory management circuit 51. The memory management circuit 51 may communicate with the host system 11 through the host interface 52. The host interface 52 may be configured to receive and identify commands and data transferred from the host system 11. For example, commands and data transferred from the host system 11 may be transferred to the memory management circuit 51 through the host interface 52. In addition, the memory management circuit 51 may transfer data to the host system 11 through the host interface 52. In this exemplary embodiment, the host interface 52 is compatible with the PCI Express standard. However, it must be understood that the disclosure is not limited thereto. The host interface 52 may also be compatible with SATA standard, PATA standard, IEEE 1394 standard, flash drive standard, SD standard, UHS-I standard, UHS-II standard, MS standard, MMC standard, eMMC standard, UFS standard, CF standard, IDE standard, or other suitable data transfer standards.

The memory interface 53 is coupled to the memory management circuit 51 and is configured to access the rewritable non-volatile memory module 43. For example, the memory management circuit 51 may access the rewritable non-volatile memory module 43 through the memory interface 53. That is, data to be written to the rewritable non-volatile memory module 43 is converted through the memory interface 53 into a format acceptable by the rewritable non-volatile memory module 43. Specifically, when the memory management circuit 51 needs to access the rewritable non-volatile memory module 43, the memory interface 53 sends corresponding command sequences. For example, these command sequences may include write command sequences indicating data writing, read command sequences indicating data reading, erase command sequences indicating data erasing, and corresponding command sequences indicating various memory operations (for example, changing a read voltage level or executing a garbage collection (GC) operation). These command sequences are, for example, generated by the memory management circuit 51 and sent to the rewritable non-volatile memory module 43 through the memory interface 53. These command sequences may include one or multiple signals, or data on the bus. These signals or data may include instruction codes or program codes. For example, in the read command sequence, information such as read identification and memory addresses are included.

In an exemplary embodiment, the memory control circuit unit 42 further includes an error detecting and correcting circuit 54, a buffer memory 55, and a power management circuit 56.

The error detecting and correcting circuit 54 is coupled to the memory management circuit 51 and is configured to execute error detecting and correcting operations to ensure data accuracy. Specifically, when the memory management circuit 51 receives a write command from the host system 11, the error detecting and correcting circuit 54 generates a corresponding error correcting code (ECC) and/or error detecting code (EDC) for the data corresponding to this write command, and the memory management circuit 51 writes the data corresponding to this write command along with the corresponding error correcting code and/or error detecting code into the rewritable non-volatile memory module 43. Later, when reading data from the rewritable non-volatile memory module 43, the memory management circuit 51 simultaneously read the error correcting code and/or error detecting code corresponding to this data, and the error detecting and correcting circuit 54 executes the error detecting and correcting operations on the read data based on this error correcting code and/or error detecting code.

The buffer memory 55 is coupled to the memory management circuit 51 and is configured to temporarily store data. The power management circuit 56 is coupled to the memory management circuit 51 and is configured to control a power of the memory storage device 10.

In an exemplary embodiment, the rewritable non-volatile memory module 43 in FIG. 4 may include a flash memory module. In an exemplary embodiment, the memory control circuit unit 42 in FIG. 4 may include a flash memory controller. In an exemplary embodiment, the memory management circuit 51 in FIG. 5 may include a flash memory management circuit.

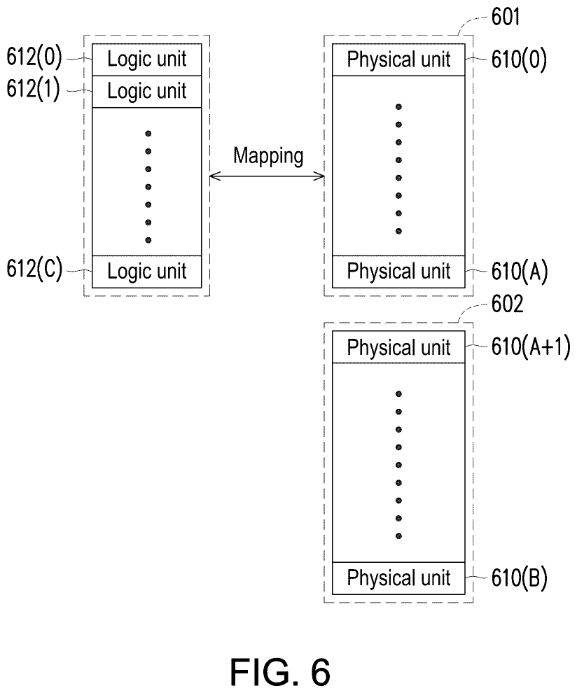

FIG. 6 is a schematic diagram of management of a rewritable non-volatile memory module according to an exemplary embodiment of the disclosure. Referring to FIG. 6, the memory management circuit 51 may logically group physical units 610(0) to 610(B) in the rewritable non-volatile memory module 43 into a storage area 601 and an idle area 602.

In an exemplary embodiment, a physical unit refers to a physical programming unit. In an exemplary embodiment, a physical unit may also refer to multiple physical programming units.

The physical units 610(0) to 610(A) of the storage area 601 are configured to store user data (for example, user data from the host system 11 in FIG. 1). For example, the physical units 610(0) to 610(A) of the storage area 601 may store valid data and invalid data. The physical units 610(A+1) to 610(B) of the idle area 602 do not store data (for example, the valid data). For example, if a physical unit does not store the valid data, then this physical unit may be associated with (or added to) the idle area 602. In addition, the physical units (or the physical units do not store the valid data) of the idle area 602 may be erased. When writing new data, one or multiple physical units may be retrieved from the idle area 602 to store the new data. In an exemplary embodiment, the idle area 602 is also called a free pool.

The memory management circuit 51 may dispose logic units 612(0) to 612(C) to map the physical units 610(0) to 610(A) of the storage area 601. In an exemplary embodiment, each logic unit corresponds to a logical address. For example, a logical address may include one or multiple logical block addresses (LBA) or other logical management units. In an exemplary embodiment, a logic unit may also correspond to a logical programming unit or be composed of multiple consecutive or non-consecutive logical addresses.

It should be noted that a logic unit may be mapped to one or multiple physical units. If a physical unit is currently mapped by a logic unit, it is shown that the data currently stored in this physical unit includes valid data. Conversely, if a physical unit is not currently mapped by any logic unit, is shown that the data currently stored in this physical unit is invalid data.

The memory management circuit 51 may record management data describing a mapping relationship between logic units and physical units (also called logical-to-physical mapping information) in at least one logical-to-physical mapping table. When the host system 11 wants to read data from the memory storage device 10 or write data to the memory storage device 10, the memory management circuit 51 may access the rewritable non-volatile memory module 43 according to the information in this logical-to-physical mapping table.

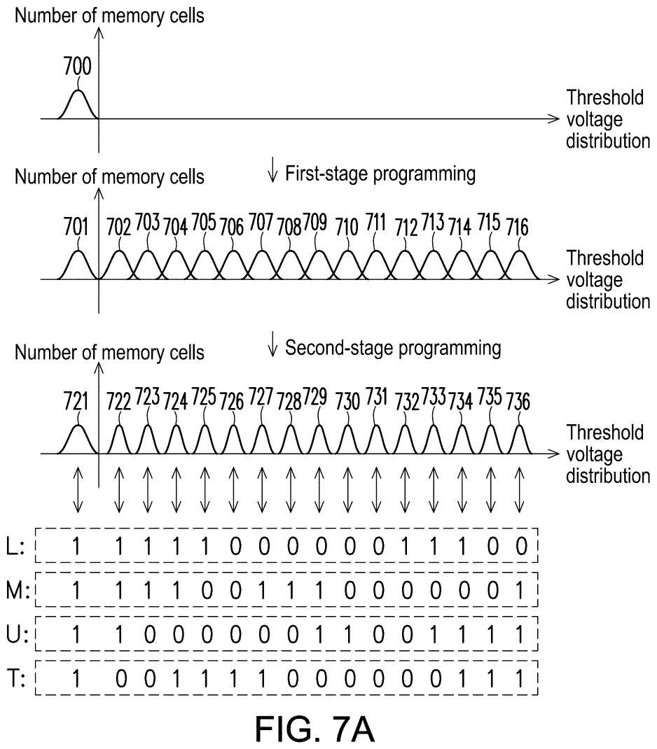

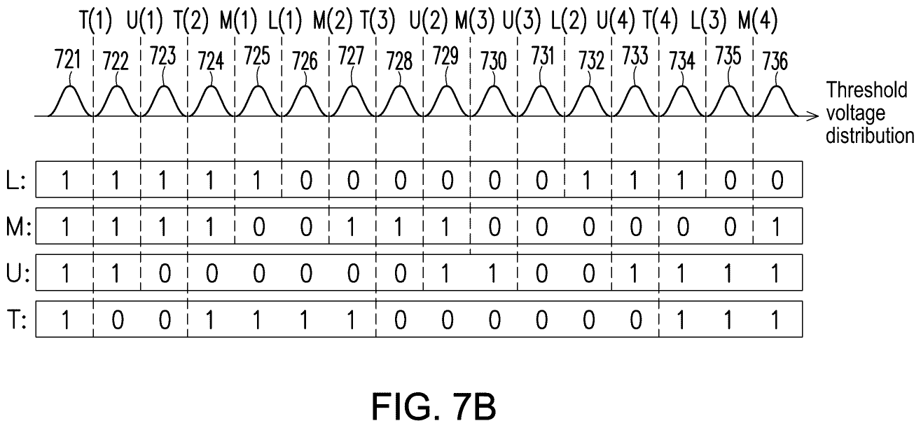

FIG. 7A is a schematic diagram of execution of stage programming on a physical unit of a rewritable non-volatile memory module to store data according to an exemplary embodiment of the disclosure. Referring to FIG. 7A, a horizontal axis represents a threshold voltage of the memory cells, while a vertical axis represents a number of memory cells with specific threshold voltages. In addition, a multi-stages programing in FIG. 7A is executed as an example for illustration based on a QLC mode, but the disclosure is not limited thereto. In an exemplary embodiment, the multi-stages programing may also be executed based on a SLC mode, a multi-MLC mode, a TLC mode, or other modes, without limitations in the disclosure.

In an exemplary embodiment, assuming that before performing the multi-stages programing on the physical units (also called first physical units) located on a word line (also called a first word line) to store data, a threshold voltage distribution of the memory cells belonging to the first physical units may only include state 700. The state 700 is also called an erased state. For example, after the erase operation is executed on the memory cells belonging to the first physical units, the threshold voltage distribution of the memory cells may only include the state 700.

In an exemplary embodiment, the memory management circuit 51 may send at least one write command sequence (also called a first write command sequence) to the rewritable non-volatile memory module 43 according to specific data (also called first data). For example, the first data may be data to be stored from the host system 11 and/or valid data collected from the rewritable non-volatile memory module 43 through the GC operation. The first write command sequence may be configured to instruct the rewritable non-volatile memory module 43 to perform the programming operation on the first physical units to store the first data.

In an exemplary embodiment, according to the first write command sequence, the rewritable non-volatile memory module 43 may perform the programming operation on the first physical units through the multi-stages programing to store the first data. Taking FIG. 7A as an example, according to the first write command sequence, the rewritable non-volatile memory module 43 may first execute a first programming (also called a first-stage programming) of the multi-stages programing on the first physical units to roughly distribute the threshold voltages of the memory cells belonging to the first physical units within voltage ranges corresponding to states 701 to 716. It should be noted that even after the first-stage programming, the programming operation (that is, the multi-stages programing) on the first physical units is still not completed (that is, the first data has not been completely stored in the first physical units).

After the first programming (that is, the first-stage programming), the rewritable non-volatile memory module 43 may execute a second programming (also called a second-stage programming) of the multi-stages programing on the first physical units to more precisely control the threshold voltages of the memory cells in states 701 to 716 within the voltage ranges corresponding to states 721 to 736. In particular, after the second-stage programming, the programming operation (that is, the multi-stages programing) on the first physical units may be considered completed (that is, the first data has been completely stored in the first physical units). In an exemplary embodiment, if the aforementioned programming operation (that is, the multi-stages programing) on the first physical units has been completed (that is, the first data has been completely stored in the first physical units), then the first data cached in the rewritable non-volatile memory module 43 and/or the buffer memory 55 may be removed.

In an exemplary embodiment, in the multi-stages programing executed on the first physical units, a programming voltage level used for the first-stage programming is different from a programming voltage level used for the second-stage programming. Taking FIG. 7A as an example, the programming voltage level used for the first-stage programming is configured to raise the threshold voltage of each memory cell to the voltage positions corresponding to the states 701 to 716. However, the programming voltage level used for the second-stage programming is configured to further raise or correct the threshold voltage of each memory cell to the voltage positions corresponding to the states 721 to 736.

It should be noted that the exemplary embodiment in FIG. 7A is described by using a 16:16 multi-stages programing mode as an example. However, in another exemplary embodiment, the aforementioned multi-stages programing may also adopt an 8:16 multi-stages programing mode or other types of multi-stages programing modes, which is not limited by the disclosure.

In an exemplary embodiment, the states 721 to 736 respectively correspond to different bit combinations in the QLC mode, namely “1111”, “1110”, “1100”, “1101”, “1001”, “0001”, “0101”, “0100”, “0110”, “0010”, “0000”, “1000”, “1010”, “1011”, “0011”, and “0111”. For example, assuming that a threshold voltage of a certain memory cell belonging to the first physical units is within the voltage range corresponding to the state 722, it is shown that the data stored in this memory cell is “1110”. Alternatively, assuming that the threshold voltage of another memory cell belonging to the first physical units is within the voltage range corresponding to the state 734, it is shown that the data stored in this memory cell is “1011”, and so on. However, the bit combinations corresponding to each of the states 721 to 736 may also be adjusted according to practical requirements, which is not limited by the disclosure.

In an exemplary embodiment, in the aforementioned 16 types of bit combinations, different bits of each bit combination respectively belong to different physical units of the first physical units. For example, in the aforementioned 16 types of bit combinations, the first to fourth bits of each bit combination may respectively belong to a physical unit (L), a physical unit (M), a physical unit (U), and a physical unit (T) of the first physical units, as shown in FIG. 7A.

In an exemplary embodiment, two of the physical unit (L), the physical unit (M), the physical unit (U), and the physical unit (T) may be regarded as the upper physical programming unit and the lower physical programming unit. According to the memory management standard adopted, the naming of the physical unit (L), the physical unit (M), the physical unit (U), and the physical unit (T) may be determined or adjusted.

In other words, in the exemplary embodiment of FIG. 7A, it is assumed that the memory cells located on the first word line may form the first physical units (that is, the physical unit (L), the physical unit (M), the physical unit (U), and the physical unit (T)). After executing the first-stage programming and the second-stage programming on the memory cells in sequence, the first data may be completely written into the first physical units.

FIG. 7B is a schematic diagram of reading of data from a programmed physical unit according to an exemplary embodiment of the disclosure. Referring to FIG. 7B, continuing from the exemplary embodiment of FIG. 7A, for the first physical units that have undergone the second-stage programming, the memory management circuit 51 may send at least one read command sequence (also called the first read command sequence) to the rewritable non-volatile memory module 43. The first read command sequence may be configured to instruct the rewritable non-volatile memory module 43 to read data (that is, the first data) from the first physical units (that is, the physical unit (L), the physical unit (M), the physical unit (U), and the physical unit (T)).

In an exemplary embodiment, according to the first read command sequence, the rewritable non-volatile memory module 43 may read data (that is, the first data) from the first physical units based on a read voltage group. For example, this read voltage group may include read voltage levels L(1) to L(3), M(1) to M(4), U(1) to U(4), and T(1) to T(4).

The read voltage levels L(1) to L(3) are configured to read data belonging to the physical unit (L) (also called first subdata). For example, by applying the read voltage levels L(1) to L(3) to the memory cells belonging to the first physical units, data belonging to the physical unit (L) (that is, the first subdata) may be obtained. The read voltage levels M(1) to M(4) are configured to read data belonging to the physical unit (M) (also called second subdata). For example, by applying the read voltage levels M(1) to M(4) to the memory cells belonging to the first physical units, data belonging to the physical unit (M) (that is, the second subdata) may be obtained. The read voltage levels U(1) to U(4) are configured to read data belonging to the physical unit (U) (also called third subdata). For example, by applying the read voltage levels U(1) to U(4) to the memory cells belonging to the first physical units, data belonging to the physical unit (U) (that is, the third subdata) may be obtained. In addition, the read voltage levels T(1) to T(4) are configured to read data belonging to the physical unit (T) (also called fourth subdata). For example, by applying the read voltage levels T(1) to T(4) to the memory cells belonging to the first physical units, data belonging to the physical unit (T) (that is, the fourth subdata) may be obtained.

In an exemplary embodiment, if the programming operation (that is, the multi-stages programing) on the first physical units has not been completed (for example, only the first-stage programming has been executed on the first physical units and the second-stage programming has not been executed), then the data stored in the first physical units (that is, the first data) subsequently has a high probability of not being correctly read out. Taking FIG. 7A as an example, if only the first-stage programming has been executed, the states 701 to 716 in the threshold voltage distribution of the memory cells belonging to the first physical units has large overlapping areas between each other. In this case, if the read voltage group in FIG. 7B is directly configured to read the memory cells, it is easy to cause data read failure due to reading too many error bits.

In an exemplary embodiment, from the beginning of executing the aforementioned programming operation (that is, the multi-stages programing) on the first physical units until this programming operation is completed, the memory management circuit 51 may save specific data (also called the second data). For example, the second data may be generated by encoding the first data. In particular, the data amount of the second data may be smaller than the total data amount of the first data. For example, the memory management circuit 51 may encode the data stored in different physical units in the first data (for example, the aforementioned first subdata, second subdata, third subdata, and fourth subdata) to generate the second data. For example, the encoding may include algorithms such as exclusive OR (XOR) encoding or other type encoding, which is not limited by the disclosure.

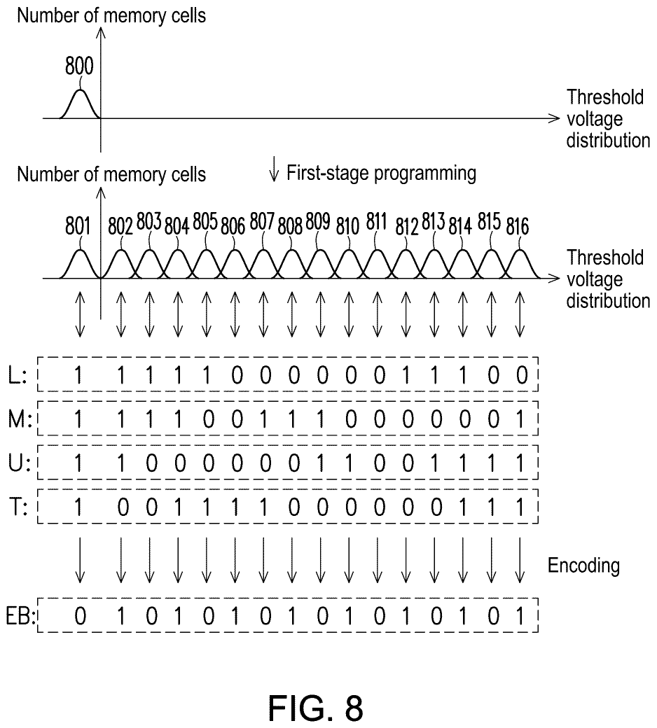

FIG. 8 is a schematic diagram of encoding of first data to generate second data according to an exemplary embodiment of the disclosure. Referring to FIG. 8, in the first-stage programming, according to the first data, the threshold voltage distribution of the memory cells belonging to the first physical units is roughly dispersed from a state 800 to states 801 to 816. For example, the states 801 to 816 may be the same as or similar to the states 701 to 716 in FIG. 7A. In this case, the threshold voltage distribution of the memory cells that have only undergone the first-stage programming (that is, the states 801 to 816) may roughly reflect the data storage state of the corresponding multiple first physical units (that is, the physical unit (L), the physical unit (M), the physical unit (U), and the physical unit (T)). However, before the second-stage programming is actually executed on the memory cells, there may be large overlapping areas between each other of the states 801 to 816.

In an exemplary embodiment, before the second-stage programming is executed on the memory cells in the states 801 to 816, the memory management circuit 51 may encode the first data (that is, the aforementioned first subdata, second subdata, third subdata, and fourth subdata) distributed and stored in the first physical units to obtain data EB (that is, the second data). For example, if the data (that is, the bit combination) stored in a memory cell is one of “1111”, “1100”, “1001”, “0101”, “0110”, “0000”, “1010”, and “0011”, then by performing the XOR encoding on the subdata stored in this memory cell belonging to the physical unit (L), the physical unit (M), the physical unit (U), and the physical unit (T) respectively (that is, the first subdata, the second subdata, the third subdata, and the fourth subdata), the corresponding data in data EB for this memory cell (also called the fifth subdata) may be encoded as “0”. Alternatively, if the data (that is, the bit combination) stored in a memory cell is one of “1110”, “1101”, “0001”, “0100”, “0010”, “1000”, “1011”, and “0111”, then by performing the XOR encoding on the subdata stored in this memory cell belonging to the physical unit (L), the physical unit (M), the physical unit (U), and the physical unit (T) respectively (that is, the first subdata, the second subdata, the third subdata, and the fourth subdata), the corresponding data in data EB for this memory cell may be encoded as “1”.

Alternatively, from another perspective, after the first-stage programming, if the threshold voltage of a memory cell is within the voltage range corresponding to one of the states 801, 803, 805, 807, 809, 811, 813, and 815, then the corresponding data in data EB for this memory cell may be encoded as “0”. Furthermore, after the first-stage programming, if the threshold voltage of a memory cell is within the voltage range corresponding to one of the states 802, 804, 806, 808, 810, 812, 814, and 816, then the corresponding data in data EB for this memory cell may be encoded as “1”.

In an exemplary embodiment, according to the data EB (that is, the second data), the memory management circuit 51 may determine the state to which each memory cell belonging to the first physical unit belongs among the states 801 to 816. For example, assuming the corresponding data in data EB for a certain memory cell is “0”, the memory management circuit 51 may deduce that the state to which this memory cell belongs among the states 801 to 816 is one of the states 801, 803, 805, 807, 809, 811, 813, and 815. Alternatively, assuming the corresponding data of the data EB for a certain memory cell is “1”, the memory management circuit 51 may deduce that the state to which this memory cell belongs among the states 801 to 816 is one of the states 802, 804, 806, 808, 810, 812, 814, and 816.

In an exemplary embodiment, according to the data EB (that is, the second data), the memory management circuit 51 may determine the actual data (that is, the bit combination) stored in each memory cell belonging to the first physical unit. For example, assuming the corresponding data of the data EB for a certain memory cell is “0”, the memory management circuit 51 may deduce that the data stored in this memory cell is one of “1111”, “1100”, “1001”, “0101”, “0110”, “0000”, “1010”, and “0011”. Alternatively, assuming the corresponding data of the data EB for a certain memory cell is “1”, the memory management circuit 51 may deduce that the data stored in this memory cell is one of “1110”, “1101”, “0001”, “0100”, “0010”, “1000”, “1011”, and “0111”.

In an exemplary embodiment, the memory management circuit 51 may save the data EB (that is, the second data) based on the SLC mode. For example, after obtaining the data EB, the memory management circuit 51 may send a write command sequence (also called a second write command sequence) to the rewritable non-volatile memory module 43. The second write command sequence may be configured to instruct the rewritable non-volatile memory module 43 to store the data EB in a certain physical unit (also called a second physical unit) in the rewritable non-volatile memory module 43. According to the second write command sequence, the rewritable non-volatile memory module 43 may store the data EB in the second physical unit based on the SLC mode. In an exemplary embodiment, the memory management circuit 51 may also save the data EB based on other operation modes, which is not limited by the disclosure.

In an exemplary embodiment, before the programming operation (that is, the multi-stages programing) for the first physical unit is completed (for example, only the first-stage programming is executed on the first physical unit and the second-stage programming has not been executed yet), the memory management circuit 51 may adjust subsequent reading (that is, the read operation) and/or writing (that is, the programming operation) for at least one of the of first physical units according to the data EB (that is, the second data). For example, the memory management circuit 51 may adjust at least one of the reading voltage level, the programming voltage level, and a decoding parameter corresponding to at least one of the first physical units according to the data EB (that is, the second data). The reading voltage level is configured to read data from at least one of the first physical units. The programming voltage level is configured to execute the second programming or the complete programming operation on the first physical units. The decoding parameter is configured to decode data read from at least one of the first physical units. In addition, more different operation behaviors and/or at least one parameter corresponding to a certain operation behavior may also be adjusted based on the data EC (that is, the second data), which is not limited by the disclosure.

In an exemplary embodiment, the decoding parameter may include a Log likelihood ratio (LLR). For example, the error detecting and correcting circuit 54 may decode data using a low-density parity-check code (LDPC code) or other decoding algorithms in conjunction with the Log likelihood ratio. In an exemplary embodiment, the decoding parameter may include other types of decoding parameters, as long as other types of decoding parameters may improve decoding performance.

In an exemplary embodiment, the memory management circuit 51 may detect an abnormal power-off event before the programming operation on the first physical unit is completed (for example, only the first-stage programming is executed on the first physical unit and the second-stage programming has not been executed yet). The abnormal power-off event causes the second-stage programming, which is expected to be executed on the first physical unit after executing the first-stage programming on the first physical unit, to be unable to be executed. For example, after executing the first-stage programming on the first physical unit, if the abnormal power-off event causes the memory storage device 10 to power off, then the second-stage programming expected to be executed on the first physical unit may not be able to be executed in the power-off state.

In an exemplary embodiment, after the aforementioned abnormal power-off event is recovered (for example, the memory storage device 10 is powered on again), the memory management circuit 51 may adjust subsequent reading (that is, the read operation) and/or writing (that is, the programming operation) for at least one of the first physical units according to the saved data EB (that is, the second data). Thereby, after the abnormal power-off event is recovered, the memory storage device 10 may be quickly restored to a normal state.

In an exemplary embodiment, the memory management circuit 51 may group the memory cells in the rewritable non-volatile memory module 43 belonging to the first physical units according to the saved data EB (that is, the second data). Then, according to a grouping result, the memory management circuit 51 may adjust subsequent reading and/or writing for at least one of the first physical units.

In an exemplary embodiment, the grouping result may reflect that a portion of memory cells (also called first memory cells) of the first physical unit belongs to one group (also called a first group), and another portion of memory cells (also called second memory cells) of the first physical unit belongs to another group (also called a second group). Taking FIG. 8 as an example, if the data in data EB corresponding to a memory cell is “0”, the memory management circuit 51 may group this memory cell (that is, the first memory cell) into the first group. Alternatively, if the data in data EB corresponding to a memory cell is “1”, the memory management circuit 51 may group this memory cell (that is, the second memory cell) into the second group.

In an exemplary embodiment, after obtaining the grouping result, the memory management circuit 51 may adjust at least one parameter (also called a first parameter) used for the aforementioned reading or writing according to the threshold voltage distribution of the first memory cells (also called a first threshold voltage distribution). In addition, the memory management circuit 51 may adjust at least one parameter (also called a second parameter) used for the aforementioned reading or writing according to the threshold voltage distribution of the second memory cells (also called a second threshold voltage distribution). The first parameter and the second parameter may be the same parameter or different parameters. For example, the first parameter and the second parameter may include at least one of the aforementioned read voltage level, programming voltage level, and decoding parameter. Then, the memory management circuit 51 may access the first physical unit according to the adjusted parameters (for example, the first parameter and/or the second parameter). For example, the memory management circuit 51 may perform the read operation or the programming operation on the first physical unit according to the adjusted parameters (for example, the first parameter and/or the second parameter). Alternatively, the memory management circuit 51 may also perform other management operations on the first physical unit according to the adjusted parameters (for example, the first parameter and/or the second parameter).

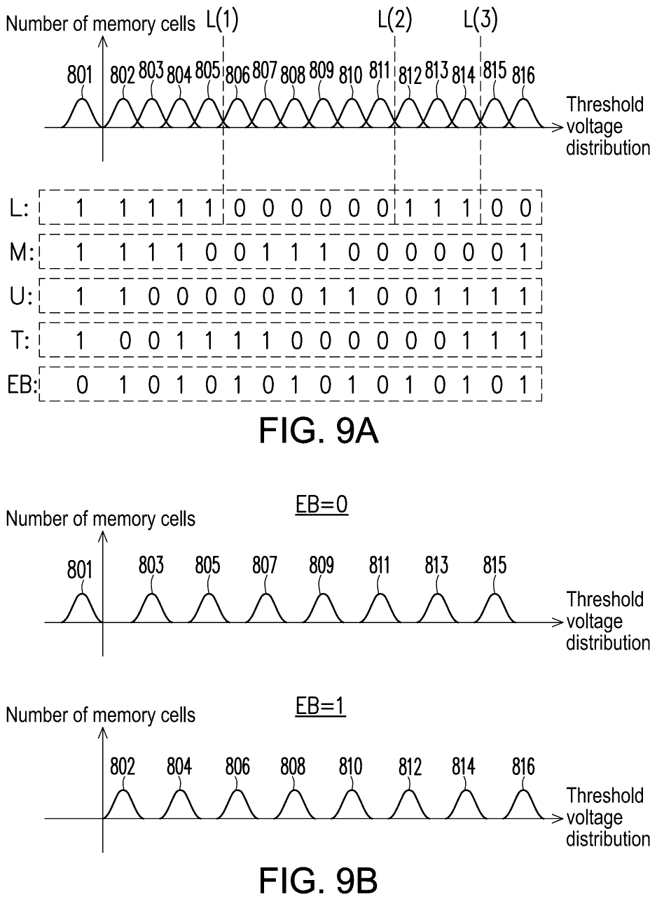

FIG. 9A is a schematic diagram of a threshold voltage distribution of memory cells after a first-stage programming according to an exemplary embodiment of the disclosure. Referring to FIG. 9A, continuing from the exemplary embodiment of FIG. 8, assuming that after performing the first-stage programming on the memory cells belonging to the first physical unit, the threshold voltage distribution of the memory cells includes the states 801 to 816. A read voltage level L(1) is between voltage ranges corresponding to the states 805 and 806 respectively. A read voltage level L(2) is between voltage ranges corresponding to the states 811 and 812 respectively. A read voltage level L(3) is between voltage ranges corresponding to the states 814 and 815 respectively.

It should be noted that, in the exemplary embodiment of FIG. 9A, since the second-stage programming has not been executed on the memory cells, large overlapping areas exist between adjacent states 805 and 806, states 811 and 812, and states 814 and 815. In this situation, if the aforementioned abnormal power-off event occurs, then after the recovery from the abnormal power-off event (for example, when the memory storage device 10 is powered on again), using the read voltage levels L(1) to L(3) to attempt to read the data stored in the physical unit (L) (that is, the first subdata) from the memory cells may have a high probability of read failure (due to reading too many error bits). At this time, under a normal situation, unless there is backup data that completely stores the first data, the first data may be permanently lost. However, if backup data that completely stores the first data exists, the backup data may occupy a lot of storage space, which results in reduced available storage space of the system.

FIG. 9B is a schematic diagram of a threshold voltage distribution of memory cells after grouping according to an exemplary embodiment of the disclosure. Referring to FIG. 9B, continuing from the exemplary embodiment of FIG. 9A, after the recovery from the abnormal power-off event (for example, when the memory storage device 10 is powered on again), the memory management circuit 51 may group the memory cells belonging to the first physical unit based on the data EB (that is, the second data) saved before or during the abnormal power-off event. For example, according to the data “0” in data EB, the memory cell (that is, the first memory cell) corresponding to the states 801, 803, 805, 807, 809, 811, 813, and 815 among the memory cells may be grouped into the first group. For example, the threshold voltage distribution of the first memory cells (that is, the first threshold voltage distribution) belonging to the first group may include the states 801, 803, 805, 807, 809, 811, 813, and 815. In addition, according to the data “1” in data EB, the memory cell corresponding to the states 802, 804, 806, 808, 810, 812, 814, and 816 among the memory cells may be grouped into the second group. For example, the threshold voltage distribution of the second memory cells (that is, the second threshold voltage distribution) belonging to the second group may include the states 802, 804, 806, 808, 810, 812, 814, and 816.

In an exemplary embodiment, the memory management circuit 51 may adjust parameters used for accessing the first physical unit according to the first threshold voltage distribution and/or the second threshold voltage distribution. Thereby, after the recovery from the abnormal power-off event (for example, when the memory storage device 10 is powered on again), using the adjusted parameters to access the first physical unit may effectively reduce a number of read error bits read.

In an exemplary embodiment, the memory management circuit 51 may adjust at least one of the read voltage levels L(1) to L(3) according to the first threshold voltage distribution and/or the second threshold voltage distribution. The adjustment of the read voltage level L(1) is used as an example for description as follows.

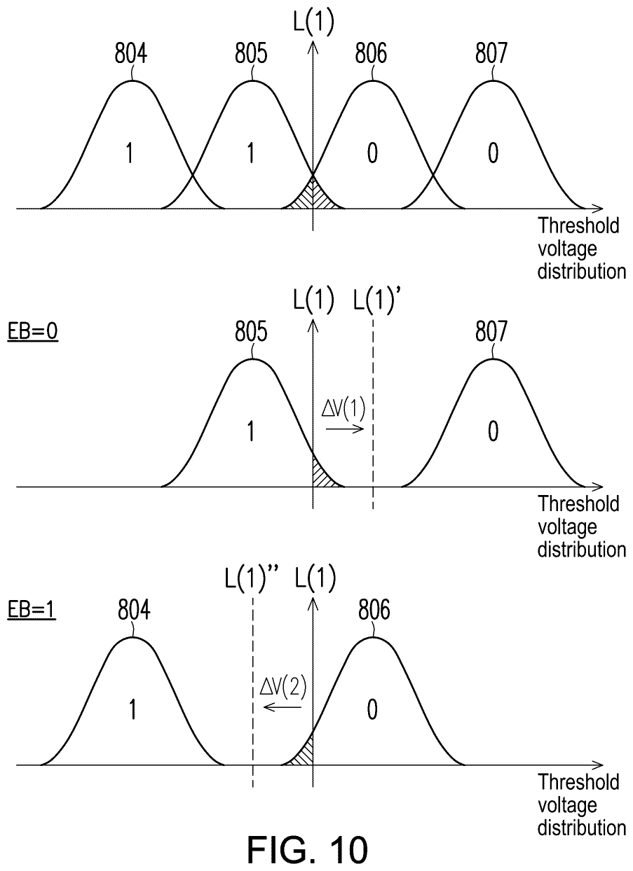

FIG. 10 is a schematic diagram of an adjustment of read voltage levels according to an exemplary embodiment of the disclosure. Referring to FIG. 10, continuing from FIG. 9A and FIG. 9B, in an exemplary embodiment, according to the first threshold voltage distribution (including the states 805 and 807), the memory management circuit 51 may add an adjustment value ΔV(1) to the read voltage level L(1) to obtain a read voltage level L(1)'. For example, a voltage position of the read voltage level L(1)′ may be located at a bottom of a V-shaped or U-shaped valley between the states 805 and 807. Regarding how to determine the adjustment value ΔV(1) and/or how to find the bottom of the V-shaped or U-shaped valley between any two states belongs to the prior art, for example, it may be achieved by analyzing the threshold voltage distribution state of the memory cells at a specific voltage interval, which is not repeated here.

After the recovery from the abnormal power-off event (for example, when the memory storage device 10 is powered on again), the memory management circuit 51 may use the read voltage level L(1)′ to read part of the data (including determining which memory cells belong to state 805) belonging to the physical unit (L) of the first physical unit, to improve the accuracy of the read data. Taking FIG. 10 as an example, compared with the read voltage level L(1), using the read voltage level L(1)′ to read part of the data belonging to the physical unit (L) of the first physical unit may change the judgment of the memory cells in a shaded area to the right of the original read voltage level L(1) in the state 805 from belonging to the state 806 to belonging to the state 805. Thereby, the number of read error bits may be effectively reduced.

In another aspect, according to the second threshold voltage distribution (including the states 804 and 806), the memory management circuit 51 may subtract an adjustment value ΔV(2) from the read voltage level L(1) to obtain a read voltage level L(1)″. For example, a voltage position of the read voltage level L(1)″ may be located at the bottom of the V-shaped or U-shaped valley between the states 804 and 806.

After the recovery from the abnormal power-off event (for example, when the memory storage device 10 is powered on again), the memory management circuit 51 may use the read voltage level L(1)′″ to read part of the data (including determining which memory cells belong to the state 806) belonging to the physical unit (L), to improve the accuracy of the read data. Taking FIG. 10 as an example, compared with the read voltage level L(1), using the read voltage level L(1)″ to read part of the data belonging to the physical unit (L) of the first physical unit may change the judgment of the memory cells in the shaded area to the left of the original read voltage level L(1) in the state 806 from belonging to state 805 to belonging to state 806. Thereby, the number of read error bits may be effectively reduced. It should be noted that the adjustment mechanism of the read voltage levels presented in the exemplary embodiment of FIG. 10 may be applied to the adjustment of other read voltage levels, which is not repeated here.

In an exemplary embodiment, the memory management circuit 51 may adjust the decoding parameters (for example, LLR) used with at least one of the read voltage levels L(1) to L(3) according to the first threshold voltage distribution and/or the second threshold voltage distribution. The adjustment of the decoding parameters used with the read voltage level L(1) is taken as an example for description as follows.

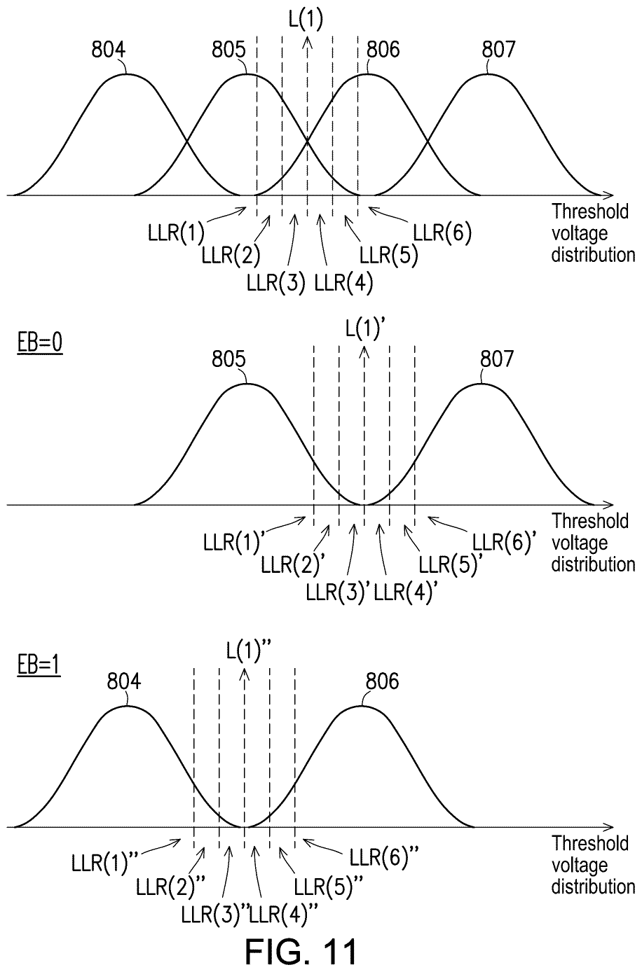

FIG. 11 is a schematic diagram of an adjustment of decoding parameters according to an exemplary embodiment of the disclosure. Referring to FIG. 11, continuing from the exemplary embodiments of FIG. 9A, FIG. 9B, and FIG. 10, after the recovery from the abnormal power-off event (for example, when the memory storage device 10 is powered on again), assuming that multiple voltage intervals are divided based on the original read voltage level L(1) and decoding parameters (for example, LLR(1) to LLR(6)) corresponding to each voltage interval are given. For example, the voltage intervals may have the same or similar voltage gaps between each other. In a situation where the states 805 and 806 overlap extensively, even with the LDPC decoding algorithm based on the LLR(1) to the LLR(6), there is still a high probability that the read data may not be successfully decoded.

In an exemplary embodiment, according to the first threshold voltage distribution (including the states 805 and 807), the memory management circuit 51 may divide the voltage intervals based on the adjusted read voltage level L(1)′ and assign decoding parameters (for example, LLR(1)′ to LLR(6)′) corresponding to each voltage interval. For example, the voltage intervals may have the same or similar voltage gaps between each other. Subsequently, the error detecting and correcting circuit 54 may decode the read data based on the read voltage level L(1)′ using the LDPC decoding algorithm with LLR(1)′ to LLR(6). Compared with using the original decoding parameters (for example, the LLR(1) to the LLR(6)) to decode the read data based on the read voltage level L(1), using the new decoding parameters (for example, the LLR(1)′ to the LLR(6)′) to decode the read data based on the read voltage level L(1)′ may effectively improve the decoding success rate.

In another aspect, according to the second threshold voltage distribution (including the states 804 and 806), the memory management circuit 51 may divide the voltage intervals based on the read voltage level L(1)″ and assign decoding parameters (for example, the LLR(1)″ to the LLR(6)″) corresponding to each voltage interval. For example, the voltage intervals may have the same or similar voltage gaps between each other. Subsequently, the error detecting and correcting circuit 54 may decode the read data based on the read voltage level L(1)″ using the LDPC decoding algorithm with the LLR(1)″ to the LLR(6)″. Compared with using the original decoding parameters (for example, the LLR(1) to the LLR(6)) to decode the read data based on the read voltage level L(1), using the new decoding parameters (for example, the LLR(1)″ to the LLR(6)″) to decode the read data based on the read voltage level L(1)″ may effectively improve the decoding success rate.

In an exemplary embodiment, the memory management circuit 51 may also correct the data (also called the third data) read from the first physical unit that has not been completely programmed (that is, the physical unit that has executed the first-stage programming but has not yet executed the second-stage programming) according to the data EB (that is, the second data) saved before or during the abnormal power-off event.

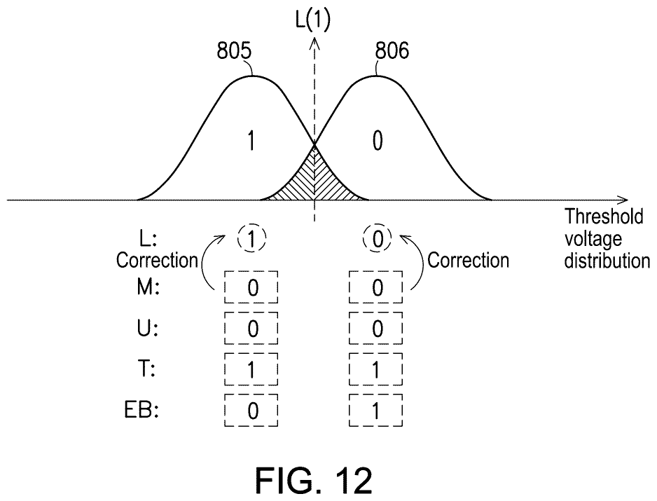

FIG. 12 is a schematic diagram of a correction of error bits according to second data according to an exemplary embodiment of the disclosure. Referring to FIG. 12, continuing from the exemplary embodiment of FIG. 9A, after the abnormal power-off event is recovered (for example, the memory storage device 10 is powered on again), using the read voltage level L(1) to attempt to read the data (that is, the first subdata) stored in the physical unit (L) from the memory cells may result in misjudgment that some memory cells belonging to the state 805 belong to the state 806 because the threshold voltage of some memory cells belonging to the state 805 is higher than the read voltage level L(1). Alternatively, the misjudgment that some memory cells belonging to the state 806 belong to the state 805 may also happens because the threshold voltage of some memory cells belonging to the state 806 is lower than the read voltage level L(1).

In an exemplary embodiment, for memory cells (also called first target memory cells) that actually belong to the state 805 but are misjudged as belonging to the state 806, the memory management circuit 51 may update the misjudged first subdata in the first target memory cells from “0” (belonging to the state 806) to “1” (belonging to the state 805) according to the data (that is, the fifth subdata) corresponding to the first target memory cells in the data EB (that is, the second data), combined with the remaining subdata read from the first target memory cells (for example, the second subdata, the third subdata, and the fourth subdata). It should be noted that the data correction process only involves logical operations (for example, an XOR operation) between multiple subdata read from the same memory cells (that is, the first target memory cells) (that is, the first subdata to the fourth subdata) combined with the data (that is, the fifth subdata) corresponding to the first target memory cell in the data EB, and may not involve the LDPC or other types of decoding algorithms employed by the error detecting and correcting circuit 54.

Similarly, for the memory cells (also called second target memory cells) that actually belong to the state 806 but are misjudged as belonging to the state 805, the memory management circuit 51 may update the misjudged first subdata in the second target memory cells from “1” (belonging to the state 805) to “0” (belonging to the state 806) according to the data (that is, the fifth subdata) corresponding to the second target memory cells in the data EB (that is, the second data), combined with the remaining subdata (for example, the second subdata, the third subdata, and the fourth subdata) read from the second target memory cells. It should be noted that the data correction process also only involves logical operations (for example, the XOR operation) between the subdata (that is, the first subdata to the fourth subdata) read from the same memory cells (that is, the second target memory cells) combined with the data (that is, the fifth subdata) corresponding to the second target memory cell in the data EB, and may not involve the LDPC or other types of decoding algorithms employed by the error detecting and correcting circuit 54.

In an exemplary embodiment, after an abnormal power-off event recovery (for example, when the memory storage device 10 is powered on again), the memory management circuit 51 may determine or adjust the programming voltage levels corresponding to these first physical units according to the data (that is, the first data) actually stored in each memory cell belonging to the first physical unit. A method of obtaining the data (that is, the first data) actually stored in each memory cell belonging to the first physical unit has been described in detail above and is not repeated here. Then, the memory management circuit 51 may execute the incomplete programming operation (for example, the second-stage programming) on the first physical unit according to the determined or adjusted programming voltage levels. Alternatively, in an exemplary embodiment, the memory management circuit 51 may instead store the first data in other physical units, which is not limited by the disclosure.

Thereby, without the need to additionally store backup data of the first data or re-obtain the first data from the host system 11, after an abnormal power-off event recovery (for example, when the memory storage device 10 is powered on again), the memory management circuit 51 may continue to complete the previously incomplete programming operation, thus improving working performance of the memory storage device 10.

In an exemplary embodiment, the data EB (that is, the second data) may also be automatically generated in response to the detected abnormal power-off event before the programming operation (that is, the multi-stages programing) on the first physical unit is completed. That is, in an exemplary embodiment, if the abnormal power-off event is not detected before the programming operation (that is, the multi-stages programing) on the first physical unit is completed, then the data EB (that is, the second data) may not be generated.

In an exemplary embodiment, the memory management circuit 51 only needs to save the data EB (that is, the second data) until the programming operation on the first physical unit (for example, the second-stage programming in the aforementioned multi-stages programing) is completed. If the programming operation on the first physical unit (for example, the second-stage programming in the aforementioned multi-stages programing) is completed, the memory management circuit 51 may remove the data EB (that is, the second data). For example, removing the data EB may refer to marking the physical unit storing the data EB as storing invalid data.

In an exemplary embodiment, the memory management circuit 51 only generates and saves the data EC (that is, the second data) corresponding to the physical unit (or the memory cell belonging to this physical unit) for the physical units that have executed the first-stage programming but have not yet executed the second-stage programming. In an exemplary embodiment, the memory management circuit 51 does not generate and/or save the data EC (that is, the second data) corresponding to the physical unit (or the memory cell belonging to this physical unit) for the physical units that have executed or completed the second-stage programming.

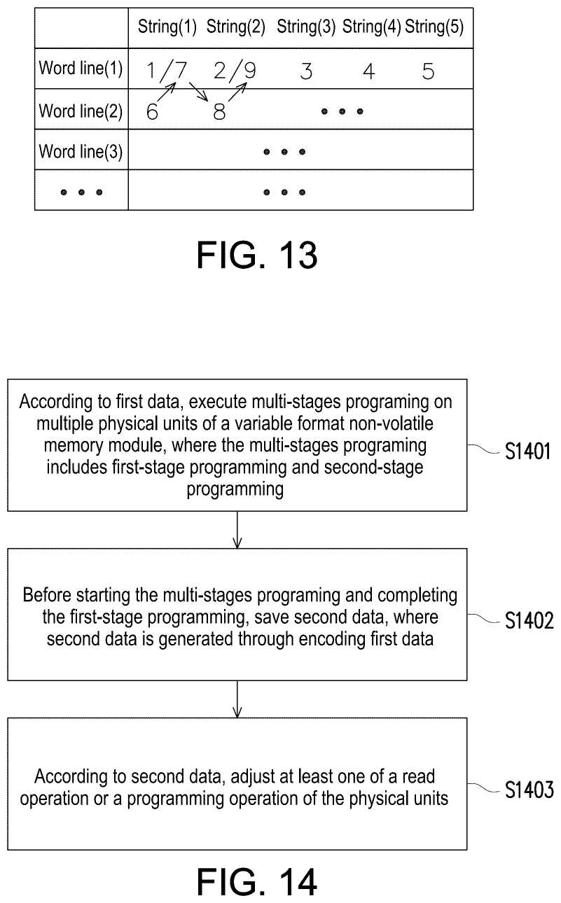

FIG. 13 is a schematic diagram of interleaved programming for memory cells on multiple word lines according to an exemplary embodiment of the disclosure. Referring to FIG. 13, in an exemplary embodiment, assuming that the rewritable non-volatile memory module 43 includes at least word line (1) to word line (3), and each word line includes string (1) to string (5). In addition, each string includes the memory cells. It should be noted that the total number of word lines included in the rewritable non-volatile memory module 43 and the total number of strings contained in each word line may be adjusted according to practical requirements.

In an exemplary embodiment, in the rewritable non-volatile memory module 43 that supports the aforementioned multi-stages programing, the rewritable non-volatile memory module 43 executes interleaved programming on multiple strings on multiple word lines to store data in the corresponding physical units. Taking FIG. 13 as an example, when writing data, the rewritable non-volatile memory module 43 may, according to numbers (indicating programming sequence) in FIG. 13, first sequentially execute the first-stage programming (corresponding to numbers 1 to 5 in FIG. 13) of the multi-stages programing on the string (1) to the string (5) on the word line (1) respectively.

After executing the first-stage programming (corresponding to the number 5 in FIG. 13) on the string (5) on the word line (1), the rewritable non-volatile memory module 43 may sequentially execute the first-stage programming(corresponding to the number 6 in FIG. 13) on the string (1) on the word line (2), execute the second-stage programming (corresponding to the number 7 in FIG. 13) on the string (1) on the word line (1), execute the first-stage programming (corresponding to the number 8 in FIG. 13) on the string (2) on the word line (2), and execute the second-stage programming (corresponding to the number 9 in FIG. 13) on the string (2) on the word line (1), and so on. Only after completely executing the first-stage programming and the second-stage programming for a certain string, this string (or the memory cells on the string) may be considered as having completed the programming operation. It should be noted that the programming sequence in FIG. 13 is only an example and is not used to limit the disclosure.

Traditionally, if an abnormal power-off event occurs before the second-stage programming for certain memory cells is completed, after the recovery from the abnormal power-off event, the memory management circuit 51 may need to re-obtain the previously incompletely stored data from the host system 11 and re-execute the write operation corresponding to this data, thereby causing bandwidth waste between the host system 11 and the memory storage device 10. Alternatively, before the second-stage programming for certain memory cells is completed, the memory management circuit 51 may retain backup data corresponding to the data to be stored in these memory cells. If an abnormal power-off event occurs, after the recovery from the abnormal power-off event, the memory management circuit 51 may re-execute data writing according to the backup data. However, if the data writing mechanism in FIG. 13 is adopted, before completing the programming operation on each word line, the memory management circuit 51 needs to retain backup data belonging to at least 6 strings, which causes rapid consumption of system storage resources.

However, in the aforementioned exemplary embodiment, by saving the second data instead of traditionally saving backup data corresponding to the first data, the system storage resources may be effectively conserved. In addition, the second data may also be configured to adjust the read operation and/or write operation for specific physical units to improve the operation performance and operation stability of the memory storage device 10.

FIG. 14 is a flowchart of a memory management method according to an exemplary embodiment of the disclosure. Referring to FIG. 14, in step S1401, according to the first data, the multi-stages programing is executed on the physical units in the rewritable non-volatile memory module. The multi-stages programing includes the first-stage programming and the second-stage programming. In step S1402, after starting to execute the multi-stages programing and before completing the second-stage programming, the second data is saved. The second data is generated by encoding the first data. In step S1403, according to the second data, the read operation or the programming operation on at least one of the physical units is adjusted.

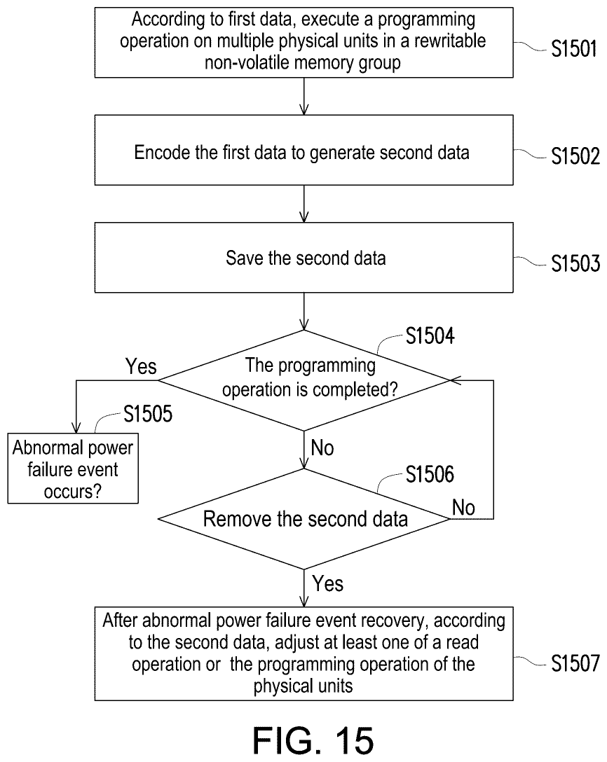

FIG. 15 is a flowchart of a memory management method according to an exemplary embodiment of the disclosure. Referring to FIG. 15, in step S1501, according to the first data, the programming operation is executed on the physical units in the rewritable non-volatile memory module. In step S1502, the first data is encoded to generate the second data. In step S1503, the second data is saved. In step S1504, it is determined whether the programming operation on the physical units has been completed. If the programming operation has been completed, in step S1505, the second data is removed.

If the programming operation has not been completed, then in step S1506, it is detected whether an abnormal power-off event has occurred. If the abnormal power-off event has occurred, in step S1507, after the recovery from the abnormal power-off event, according to the second data, the read operation or the programming operation on at least one of the physical units is adjusted. If no abnormal power-off event has occurred, the process may return to step S1504.

However, the steps in FIG. 14 and FIG. 15 have been described in detail as above, and are not repeated here. It is worth noting that the steps in FIG. 14 and FIG. 15 may be implemented as multiple codes or circuits, which is not limited by the disclosure. In addition, the methods of FIG. 14 and FIG. 15 may be used in conjunction with the aforementioned exemplary embodiments, or may be used independently, which is not limited by the disclosure.

In summary, the memory management method, the memory storage device, and the memory control circuit unit provided by the disclosure may temporarily store the corresponding encoded data (that is, the second data) before the multi-stages programing on the physical units is actually completed. Thereby, if the abnormal power-off event occurs during the execution of the multi-stages programing, subsequent recovery operations may be quickly executed or related settings may be adjusted according to the encoded data, thus improving the working performance of the memory storage device.

Although the disclosure has been disclosed by the above implementations, it is not intended to limit the disclosure. Any person of ordinary skill in the art may make some modifications and refinements without departing from the spirit and scope of the disclosure. Therefore, the protection scope of the disclosure shall be defined by the appended claims.

What is claimed is:

1. A memory management method, for a rewritable non-volatile memory module, comprising:
according to first data, executing a multi-stages programing on a plurality of physical units in the rewritable non-volatile memory module, wherein the multi-stages programing comprises a first-stage programming and a second-stage programming;
before starting to execute the multi-stages programing and before completing the second-stage programming, saving second data, wherein the second data is generated by encoding the first data; and
according to the second data, adjusting a read operation or a programming operation on at least one of the plurality of physical units.

2. The memory management method according to claim 1, wherein the plurality of physical units belong to the same word line.

3. The memory management method according to claim 2, wherein the plurality of physical units comprise at least an upper physical programming unit and a lower physical programming unit.

4. The memory management method according to claim 1, wherein the step of adjusting the read operation or the programming operation of the at least one of the plurality of physical units according to the second data comprises:
according to the second data, adjusting the read operation or the programming operation of the at least one of the plurality of physical units that has completed the first-stage programming and has not completed the second-stage programming.

5. The memory management method according to claim 1, wherein the step of adjusting the read operation or the programming operation of the at least one of the plurality of physical units according to the second data comprises:
after completing the first-stage programming, detecting an abnormal power-off event before completing the second-stage programming; and
after recovery from the abnormal power-off event, according to the second data, adjusting the read operation or the programming operation of the at least one of the plurality of physical units that has completed the first-stage programming and has not completed the second-stage programming.

6. The memory management method according to claim 1, wherein the step of adjusting the read operation or the programming operation of the at least one of the plurality of physical units according to the second data comprises:
according to the second data, grouping a plurality of memory cells in the rewritable non-volatile memory module corresponding to the plurality of physical units; and
according to a grouping result, adjusting the read operation or the programming operation of the at least one of the plurality of physical units that has completed the first-stage programming and has not completed the second-stage programming.

7. The memory management method according to claim 6, wherein the step of adjusting the read operation or the programming operation of the at least one of the plurality of physical units that has completed the first-stage programming and has not completed the second-stage programming according to the grouping result comprises:
according to a first threshold voltage distribution of a plurality of first memory cells belonging to a first group among the plurality of memory cells, adjusting a first parameter for the read operation or the programming operation; and
according to a second threshold voltage distribution of a plurality of second memory cells belonging to a second group among the plurality of memory cells, adjusting a second parameter for the read operation or the programming operation.

8. The memory management method according to claim 1, wherein the step of adjusting the read operation or the programming operation of the at least one of the plurality of physical units according to the second data comprises:
according to the second data, adjusting at least one of a read voltage level, a programming voltage level, and a decoding parameter corresponding to the at least one of the plurality of physical units.

9. The memory management method according to claim 1, further comprising:
in response to an abnormal power-off event before completing the second-stage programming, generating the second data.

10. The memory management method according to claim 1, further comprising:
according to the second data, correcting third data read from the at least one of the plurality of physical units that has completed the first-stage programming and has not completed the second-stage programming.

11. The memory management method according to claim 1, further comprising:
not saving the second data for the plurality of physical units that have completed the second-stage programming.

12. The memory management method according to claim 1, wherein in the multi-stages programing executed on the plurality of physical units, a programming voltage level for the first-stage programming is different from a programming voltage level for the second-stage programming.

13. A memory storage device, comprising:
a connecting interface unit, configured to couple to a host system;
a rewritable non-volatile memory module; and
a memory control circuit unit, coupled to the connecting interface unit and the rewritable non-volatile memory module,
wherein the memory control circuit unit is configured to:
according to first data, execute a multi-stages programing on a plurality of physical units in the rewritable non-volatile memory module, wherein the multi-stages programing comprises a first-stage programming and a second-stage programming;
before starting to execute the multi-stages programing and before completing the second-stage programming, save second data, wherein the second data is generated by encoding the first data; and
according to the second data, adjust a read operation or a programming operation on at least one of the plurality of physical units.

14. The memory storage device according to claim 13, wherein the plurality of physical units belong to the same word line.

15. The memory storage device according to claim 14, wherein the plurality of physical units comprise at least an upper physical programming unit and a lower physical programming unit.

16. The memory storage device according to claim 13, wherein the operation of the memory control circuit unit adjusting the read operation or the programming operation on at least one of the plurality of physical units according to the second data comprises:
according to the second data, adjusting the read operation or the programming operation on at least one of the plurality of physical units that has completed the first-stage programming but has not completed the second-stage programming.

17. The memory storage device according to claim 13, wherein the operation of the memory control circuit unit adjusting the read operation or the programming operation on at least one of the plurality of physical units according to the second data comprises:
after completing the first-stage programming, detecting an abnormal power-off event before completing the second-stage programming; and
after recovery from the abnormal power-off event, according to the second data, adjusting the read operation or the programming operation on at least one of the plurality of physical units that has completed the first-stage programming but has not completed the second-stage programming.

18. The memory storage device according to claim 13, wherein the operation of the memory control circuit unit adjusting the read operation or the programming operation on at least one of the plurality of physical units according to the second data comprises:
according to the second data, grouping a plurality of memory cells in the rewritable non-volatile memory module corresponding to the plurality of physical units; and
according to a grouping result, adjusting the read operation or the programming operation on at least one of the plurality of physical units that has completed the first-stage programming but has not completed the second-stage programming.

19. The memory storage device according to claim 18, wherein the operation of the memory control circuit unit adjusting the read operation or the programming operation on at least one of the plurality of physical units that has completed the first-stage programming but has not completed the second-stage programming according to the grouping result comprises:
according to a first threshold voltage distribution of a plurality of first memory cells belonging to a first group among the plurality of memory cells, adjusting a first parameter for the read operation or the programming operation; and
according to a second threshold voltage distribution of a plurality of second memory cells belonging to a second group among the plurality of memory cells, adjusting a second parameter for the read operation or the programming operation.

20. The memory storage device according to claim 13, wherein the operation of the memory control circuit unit adjusting the read operation or the programming operation on at least one of the plurality of physical units according to the second data comprises:
according to the second data, adjusting at least one of a read voltage level, a programming voltage level, and a decoding parameter corresponding to at least one of the plurality of physical units.

21. The memory storage device according to claim 13, wherein the memory control circuit unit is further configured to:
in response to an abnormal power-off event before completing the second-stage programming, generate the second data.

22. The memory storage device according to claim 13, wherein the memory control circuit unit is further configured to:
according to the second data, correct third data read from at least one of the plurality of physical units that has completed the first-stage programming but has not completed the second-stage programming.

23. The memory storage device according to claim 13, wherein the memory control circuit unit is further configured to:
not to save the second data for the plurality of physical units that have completed the second-stage programming.

24. The memory storage device according to claim 13, wherein in the multi-stages programing executed on the plurality of physical units, a programming voltage level for the first-stage programming is different from a programming voltage level for the second-stage programming.

25. A memory control circuit unit, configured to control a rewritable non-volatile memory module, and comprising:
a host interface, configured to couple to a host system;
a memory interface, configured to couple to the rewritable non-volatile memory module; and
a memory management circuit, coupled to the host interface and the memory interface,
wherein the memory management circuit is configured to:
according to first data, execute a multi-stages programing on a plurality of physical units in the rewritable non-volatile memory module, wherein the multi-stages programing comprises a first-stage programming and a second-stage programming;
before starting to execute the multi-stages programing and before completing the second-stage programming, save second data, wherein the second data is generated by encoding the first data; and
according to the second data, adjust a read operation or a programming operation on at least one of the plurality of physical units.

26. The memory control circuit unit according to claim 25, wherein the plurality of physical units belong to the same word line.

27. The memory control circuit unit according to claim 26, wherein the plurality of physical units comprise at least an upper physical programming unit and a lower physical programming unit.

28. The memory control circuit unit according to claim 25, wherein the operation of the memory management circuit adjusting the read operation or the programming operation of the at least one of the plurality of physical units according to the second data comprises:
according to the second data, adjusting the read operation or the programming operation of the at least one of the plurality of physical units that has completed the first-stage programming and has not completed the second-stage programming.

29. The memory control circuit unit according to claim 25, wherein the operation of the memory management circuit adjusting the read operation or the programming operation of the at least one of the plurality of physical units according to the second data comprises:
after completing the first-stage programming, detecting an abnormal power-off event before completing the second-stage programming; and
after recovery from the abnormal power-off event, according to the second data, adjusting the read operation or the programming operation of the at least one of the plurality of physical units that has completed the first-stage programming and has not completed the second-stage programming.

30. The memory control circuit unit according to claim 25, wherein the operation of the memory management circuit adjusting the read operation or the programming operation of the at least one of the plurality of physical units according to the second data comprises:
according to the second data, grouping a plurality of memory cells in the rewritable non-volatile memory module corresponding to the plurality of physical units; and
according to a grouping result, adjusting the read operation or the programming operation of the at least one of the plurality of physical units that has completed the first-stage programming and has not completed the second-stage programming.

31. The memory control circuit unit according to claim 30, wherein the operation of the memory management circuit adjusting the read operation or the programming operation of the at least one of the plurality of physical units that has completed the first-stage programming and has not completed the second-stage programming according to the grouping result comprises:
according to a first threshold voltage distribution of a plurality of first memory cells belonging to a first group among the plurality of memory cells, adjusting a first parameter for the read operation or the programming operation; and
according to a second threshold voltage distribution of a plurality of second memory cells belonging to a second group among the plurality of memory cells, adjusting a second parameter for the read operation or the programming operation.

32. The memory control circuit unit according to claim 25, wherein the operation of the memory management circuit adjusting the read operation or the programming operation of the at least one of the plurality of physical units according to the second data comprises:
according to the second data, adjusting at least one of a read voltage level, a programming voltage level, and a decoding parameter corresponding to the at least one of the plurality of physical units.

33. The memory control circuit unit according to claim 25, wherein the memory management circuit is further configured to:
in response to an abnormal power-off event before completing the second-stage programming, generate the second data.

34. The memory control circuit unit according to claim 25, wherein the memory management circuit is further configured to:
according to the second data, correct third data read from the at least one of the plurality of physical units that has completed the first-stage programming and has not completed the second-stage programming.

35. The memory control circuit unit according to claim 25, wherein the memory management circuit is further configured to:
not to save the second data for the plurality of physical units that have completed the second-stage programming.

36. The memory control circuit unit according to claim 25, wherein in the multi-stages programing executed on the plurality of physical units, a programming voltage level for the first-stage programming is different from a programming voltage level for the second-stage programming.
